(19) United States
(12) Patent Application Publication
(10) Pub. No.: US 2012/0010062 A1
(43) Pub. Date: Jan. 12, 2012

(54) BLOOD PROCESSING APPARATUS AND METHOD WITH AUTOMATICALLY ADJUSTED COLLECTION TARGETS

(75) Inventors: Christopher FLETCHER, Boulder, CO (US); John PITTINGER, Evergreen, CO (US)

(73) Assignee: CARIDIANBCT, INC., Lakewood, CO (US)

(21) Appl. No.: 13/164,586

(22) Filed: Jun. 20, 2011

Related U.S. Application Data
(60) Provisional application No. 61/363,026, filed on Jul. 9, 2010.

(51) Int. Cl. B04B 11/06; B04B 15/00; B01D 21/26

(52) U.S. Cl. 494/10; 494/37; 494/60

(57) ABSTRACT

A method and apparatus for collecting a maximum amount of platelets for a selected blood separation procedure without collecting excess platelets above those required for a selected platelet product, whether that product was one unit of platelets, two units of platelets (a double platelet), or more. The method and apparatus will continue to adjust the platelet yield target for platelet collection throughout the procedure without operator intervention, unless the selected procedure cannot be completed successfully, and the operator is required to select another allowed procedure.

### CROSS REFERENCE TO RELATED APPLICATIONS

This application claims the benefit of U.S. Provisional Application No. 61/363,026 filed Jul. 9, 2010.

### BACKGROUND OF THE INVENTION

1. Field of the Invention

The present invention relates to an apparatus and method for separating particles or components of a biologic fluid, such as blood. The invention has particular advantages in connection with separating blood components, such as white blood cells and platelets.

2. Description of the Related Art

In many different fields, liquids carrying particles must be filtered or processed to obtain either a purified liquid or purified particle end product. In its broadest sense, a filter is any device capable of removing or separating particles from a substance. Thus, the term “filter” as used herein is not limited to a porous media material but includes many different types of devices and processes where particles are either separated from one another or from liquid.

In the medical field, it is often necessary to filter blood. Whole blood consists of various liquid components and particle components. The liquid portion of blood is largely made up of plasma, and the particle components include red blood cells (erythrocytes), white blood cells (leukocytes), and platelets (thrombocytes). While these constituents have similar densities, their average density relationship, in order of decreasing density, is as follows: red blood cells, white blood cells, platelets, and plasma. In addition, the particle components are related according to size, in order of decreasing size, as follows: white blood cells, red blood cells, and platelets. Most current purification devices rely on density and size differences or surface chemistry characteristics to separate and/or filter the blood components.

Typically, donated platelets are separated or harvested from other blood components using a centrifuge. White cells or other selected components may also be harvested. The centrifuge rotates a blood separation vessel to separate components within the vessel or reservoir using centrifugal force. In use, blood enters the separation vessel while it is rotating at a very rapid speed and centrifugal force stratifies the blood components, so that particular components may be separately removed. Components are removed through ports arranged within stratified layers of blood components.

White blood cells and platelets in plasma form a medium-density, stratified layer or “buffy coat”. Because typical centrifuge collection processes are unable to consistently and satisfactorily separate white blood cells from platelets in the buffy coat, other processes have been added to improve results. In one procedure, after centrifuging, platelets are passed through a porous woven or non-woven media filter, which may have a modified surface, to remove white blood cells. However, use of the porous filter introduces its own set of problems. Conventional porous filters may be inefficient because they may permanently remove or trap approximately 5-20% of the platelets. These conventional filters may also reduce “platelet viability”, meaning that once the platelets pass through a filter, a percentage of the platelets cease to function properly and may be partially or fully inactivated. In addition, porous filters may cause the release of bradykinin, an inflammation mediator and vasodialator, which may lead to hypotensive episodes in a patient. Porous filters are also expensive and often require additional time-consuming manual labor to perform a filtration process. Although porous filters are effective in removing a substantial number of white blood cells, inactivated platelets may clog the filter. Therefore, the use of at least some porous filters is not feasible in on-line processes.

Another separation process is one known as centrifugal elutriation. This process separates cells suspended in plasma without the use of a membrane filter. The plasma, which carries the cells in suspension, is introduced into a funnel-shaped chamber located on a spinning centrifuge. As additional liquid flows through the chamber, it sweeps smaller sized, slower-sedimenting cells toward an elutriation boundary within the chamber, while larger, faster-sedimenting cells migrate to an area of the chamber having the greatest centrifugal force. This type of chamber, called a leuko-reduction or LRS chamber, is described, for example, in U.S. Pat. No. 5,674,173 and U.S. Pat. No. 6,053,856.

An apheresis centrifugal blood separation device collects certain preselected blood components from a donor while returning other components to the donor. The collected components are intended to be segregated into units, sometimes referred to as “products”, which will be re-infused into a patient. A product of a selected cell type, for instance platelets, must have a selected number of cells or volume to qualify to be administered to a patient. A particular donor may be capable of donating certain amounts and types of cells at a particular time. This capability determines the number and types of products that can be collected from the donor during a particular donation procedure. It is advantageous to optimize the collection procedure to collect the maximum number of qualifying products in the least amount of time. Although the result of a donation procedure is finally determined after the completion of collection, it is possible to predict the types and number of products that could be collected from a donor. It is important, however, to increase the probability that the collected blood components will comprise a set of complete products, without collecting excess components, which would merely be wasted.

### SUMMARY OF THE INVENTION

The present invention comprises a centrifuge for separating particles suspended in a fluid, particularly blood and blood components. The apparatus has a blood processing vessel mounted on a rotor of a centrifuge. A method is provided to collect a maximum number of products from a donor, but not to collect an excess number of cells above the number of cells required for the maximum possible number of products. Collecting excess cells needlessly depletes the cells of the donor, takes additional time both for the donor and the operator, and for the use of the machine, and wastes excess collected blood components. The present invention seeks to optimize collection of a reliable number of products by allowing an operator to select a target number of products, for example, a double platelet product. The apparatus selects a target number of cells (platelets) for collection within a preselected range, based on donor characteristics, and seeks to optimize the probability that the selected number of products will actually be collected. Multiple ranges are provided, for example, a range for a single product, for a double product, and for a triple product. The adjacent ranges are separated by zones which are numbers of cells that are too high for a lower range and too low for an adjacent higher range. The apparatus will not attempt to perform a process that would withdraw a number of cells within a zone.

It is an object of the present invention to provide a blood cell collection system comprising a centrifuge rotor; a blood processing chamber mounted on said rotor; and means for collecting a maximum amount of platelets for a selected platelet product without collecting excess platelets.

It is also an object to provide a method for controlling a centrifugal blood separation device comprising identifying a maximum quantity of platelets that a donor is qualified to donate, identifying a range of platelet quantities containing said maximum quantity, said range comprising allowed platelet quantities associated with a discrete platelet product amount, identifying a procedure-specific quantity of platelets for each of a plurality of blood collection procedures, said procedure-specific quantity being less than said maximum quantity, being within said range, and being a maximum for a specific procedure, and collecting said procedure-specific quantity of platelets in connection with its associated specific procedure.

Another object is identifying a plurality of ranges, each range being separated from an adjacent range by a zone.

Another object is to prevent procedure-specific quantities of platelets from taking values within zones.

It is also an object to repeat identifying steps during a procedure and adjusting the procedure specific quantity during the procedure without operator intervention.

Another object is selecting an alternative procedure when a selected procedure is no longer qualified to collect an acceptable quantity of platelets, and collecting a procedure-specific quantity of platelets associated with said alternative procedure.

It is to be understood that both the foregoing general description and the following detailed description are exemplary, and are intended to provide further explanation of the invention as claimed.

### BRIEF DESCRIPTION OF THE DRAWINGS

FIG. 1 is a schematic view of one embodiment of an apheresis system, which can be used in or with the present invention.

FIG. 2 illustrates a tubing and bag set including an extracorporeal tubing circuit, a cassette assembly, and collection bag assembly for use in or with the system of FIG. 1 pursuant to the present invention.

FIG. 3 is a perspective view of a blood processing vessel and the cell separation chamber.

FIG. 4 is a graph of regions of allowable platelet yield values with intervening zones.

FIG. 5 is a flow chart illustrating a method for controlling the apheresis system of FIG. 1.

FIG. 6 is an expanded portion of the flow chart of FIG. 5.

### DETAILED DESCRIPTION

To describe the present invention, reference will now be made to the accompanying drawings. The present invention may be used with a blood processing apparatus such as a TRIMA® or TRIMA ACCEL® blood component centrifuge manufactured by CaridianBCT, Inc. The invention may also be used with other blood component centrifuges. The Trima or Trima Accel centrifuges incorporate a one-omega/two-omega seal-less tubing connection as disclosed in U.S. Pat. No. 4,425,112 to Ito, and as know in the art to provide a continuous flow of blood to and from the rotor of an operating centrifuge without requiring a rotating seal.

The present invention comprises a method and apparatus for collecting a maximum amount of platelets for a selected blood separation procedure without collecting excess platelets above those required for a selected platelet product, whether that product was one unit of platelets, two units of platelets (a double platelet), or more. The method and apparatus will continue to adjust the platelet yield target for platelet collection throughout the procedure without operator intervention, unless the selected procedure cannot be completed successfully, and the operator is required to select another allowed procedure.

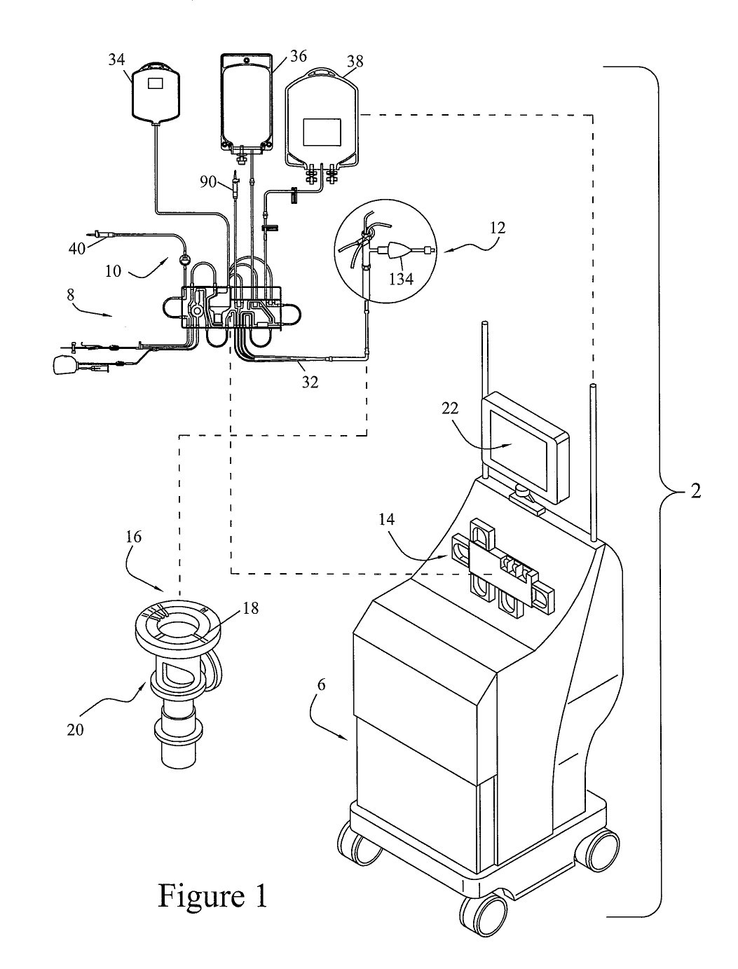

A preferred blood apheresis system 2 for use with the present invention is schematically illustrated in FIG. 1. System 2 provides for a continuous blood component separation process. Generally, whole blood is withdrawn from a donor and is substantially continuously provided to a blood component separation device 6 where the blood is separated into various components and at least one of these blood components is collected from the device 6. One or more of the separated blood components may be either collected for subsequent use or returned to the donor. In the blood apheresis system 2, blood is withdrawn from the donor and directed through a bag and tubing set 8, which includes an extracorporeal tubing circuit 10, and a blood processing vessel 12, which together define a closed, sterile and disposable system. The set 8 is adapted to be mounted in the blood component separation device 6 or apheresis system. The separation device 6 includes a pump/valve/sensor assembly 14, which interfaces with the extracorporeal tubing circuit 10, and a centrifuge assembly 16, which interfaces with the blood processing vessel 12.

The centrifuge assembly 16 may include a channel 18 in a rotatable rotor assembly 20, which provides the centrifugal forces required to separate blood into its various blood component types by centrifugation. The blood processing vessel 12 may then be fitted within the channel 18. Blood can flow substantially continuously from the donor, through the extracorporeal tubing circuit 10, and into the rotating blood processing vessel 12. Within the blood processing vessel 12, blood may be separated into various blood component types and at least one of these blood component types (e.g., white blood cells, platelets, plasma, or red blood cells) may be removed from the blood processing vessel 12. Blood components that are not being retained for collection or for therapeutic treatment (e.g., platelets and/or plasma) are also removed from the blood processing vessel 12 and returned to the donor via the extracorporeal tubing circuit 10. Various alternative apheresis systems (not shown) may also make use of the present invention, including batch processing systems (non-continuous inflow of whole blood and/or non-continuous outflow of separated blood components) or smaller scale batch or continuous RBC/plasma separation systems, whether or not blood components may be returned to the donor.

Operation of the blood component separation device 6 is controlled by one or more processors included therein, and may advantageously comprise a plurality of embedded computer processors to accommodate interface with ever-increasing PC user facilities (e.g., CD ROM, modem, audio, networking and other capabilities). In order to assist the operator of the apheresis system 2 with various aspects of its operation, the blood component separation device 6 includes a graphical interface 22 with an interactive touch screen.

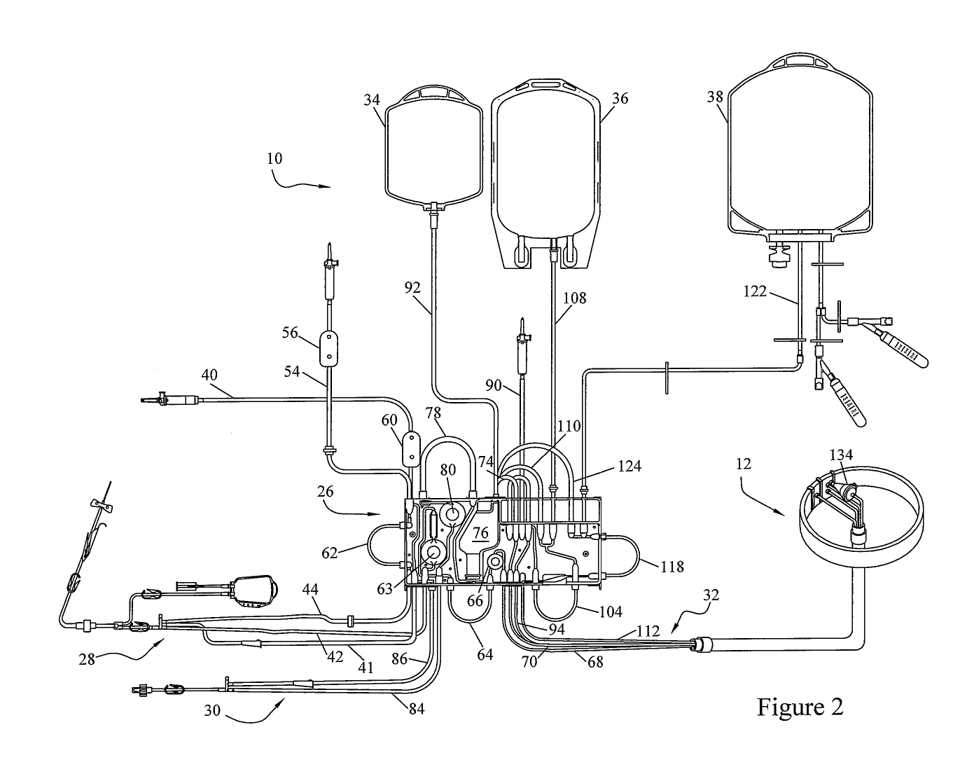

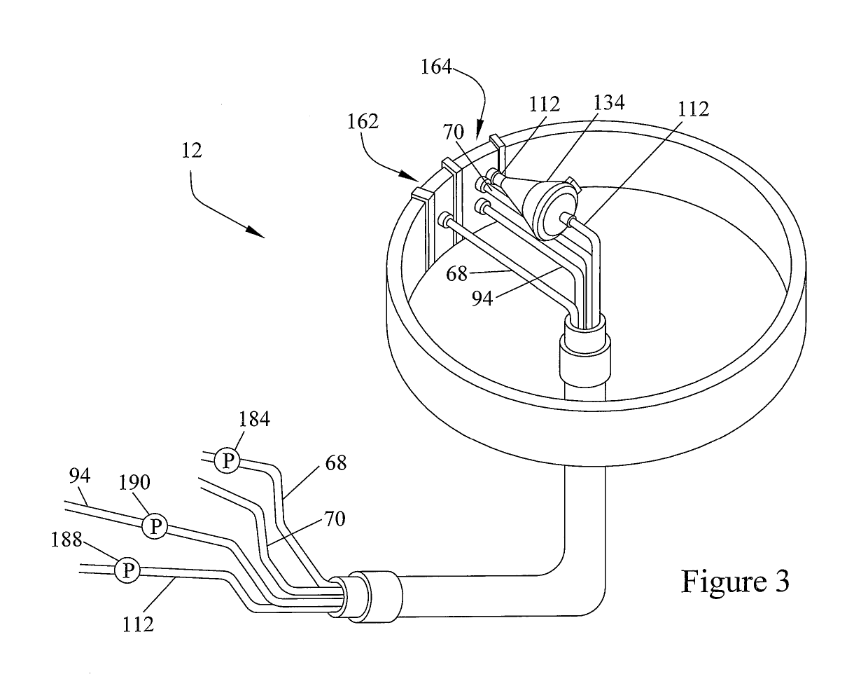

An extracorporeal tubing circuit 10, shown in FIG. 2, may include a cassette 26 and a number of tubing/collection assemblies 28, 30, 32, 34, 36, 38 and 40. A blood removal tubing assembly 28 provides a needle interface for withdrawing blood from a donor to the remainder of the tubing circuit 10. A blood return tubing assembly 30 provides a needle interface for returning blood components and other fluids to the donor. A single needle interface may also be used. Three lines 41, 42, 44 are provided in blood removal tubing assembly 28 (see FIG. 3) for removal of blood from the donor. A cassette 26 is connected between the tubing assembly 28, which connects to the donor, and blood inlet/blood component tubing line sub-assembly 32, which provides the interface between cassette 26 and blood processing vessel 12. The cassette 26 orients tubing segments in predetermined spaced relationships within the cassette 26 for ultimate engagement with valve members on apheresis device 6. Such valves will, when activated, control flow through loops and tubing.

Four lines 68, 70, 94 and 112 are shown in FIG. 2 for transport of blood and components to and from the processing vessel 12. An anticoagulant tubing assembly 40, a vent bag 34, a plasma collection assembly 36, and a white blood cell collection bag 38 are also interconnected with cassette 26. The extracorporeal tubing circuit 10 and blood processing vessel 12 are pre-connected to form a closed, sterilized, disposable assembly for a single use.

When the tubing circuit 10 has been mounted on the blood component separation device 6, saline solution primes the tubing circuit through a saline line 54 and filter 56 (see FIG. 2). Saline flows through an internal passageway in the cassette 26 and through the line 41 to the distal end of the blood removal assembly 28. Saline can then flow up a blood withdrawal line 42 into the other tubes and passageways of the circuit 10 and up an anticoagulant line 44 in preparation for blood processing. A supply or bag (not shown) of anticoagulant connects to a distal end of the anticoagulant tubing assembly 40. Anticoagulant solution flows past a filter 60 and a first pump loop 62 through the anticoagulant line 44 to the distal end of the blood removal assembly. The pump loop 62 and other pump loops described herein couple with peristaltic pumps on the blood processing device 6 in a known manner. The device 6 controls the direction and rate of flow of the fluids described herein by controlling the speed and direction of the peristaltic pumps and the position of various valves.

The blood removal line 42 conducts blood into the cassette 26, where the blood passes a first pressure sensor 63 and a second pump loop 64. A second pressure sensor 66, between second pump loop 64 with its associated pump and blood inflow line 68 to the blood processing vessel 12, senses the fluid pressure effective at an inlet to the blood processing vessel 12. Emanating from blood processing vessel 12 is an RBC outlet tubing line 70 of the blood inlet/blood component tubing assembly 32. The outlet tubing line 70 connects to an external loop 74 to a return reservoir 76. The return reservoir 76 contacts sensors on the device 6 that detect low and high fluid levels. The device 6 keeps the fluid in the reservoir between these two levels by controlling flow out of the reservoir past a return pump loop 78 and a return pressure sensor 80. As the fluid level in the reservoir 76 is constantly rising and falling, a vent bag 34 connects to the reservoir 76 through a vent tube 92. Air can flow between the reservoir 76 and the vent bag 34 in a sterile manner. Fluid flows into a return tube 84 in the blood return assembly 30. The return assembly 30 also comprises a saline line 86 connected internally in the cassette 26 to saline line 54 for priming as described above. If desired, red blood cells could be withdrawn through the replacement line 90 and collected in a collection bag (not shown).

Plasma may also be collected from the blood processing vessel 12 into plasma bag 36. When desired, plasma is withdrawn from the blood processing vessel 12 through plasma line 94 to a pump loop 104. A valve (not shown) diverts the plasma either into a collect tube 108 to the plasma bag 36, or into a connecting loop 110 to the reservoir 76. Excess plasma in the reservoir 76 is returned to the donor in the same way as red blood cells, as described above.

White blood cells flow out of the blood processing vessel 12 through a fourth cell line 112 in the tubing line sub-assembly 32. In the cassette 26, a red-green photo sensor (not shown) may be used to control periodic flushing of white blood cells out of the blood processing vessel 12 into the collect bag 38. The white blood cells flow through a pump loop 118, which engages a peristaltic pump on the separation device 6. The pump loop 118 connects to a valved passageway in the cassette 26. The blood processing device 6 can control a valve to direct white blood cells either into a collect tube 122 and thence into the collect bag 38, or into a connection loop 124 and thence into the reservoir 76. Excess white blood cells in the reservoir 76 may be returned to the donor in the same way as red blood cells and plasma, as described above.

During a blood removal, whole blood will be passed from a donor into tubing line 42 of blood removal tubing assembly 28. The blood is pumped by the device 6 via pump loop 64, to the blood processing vessel 12 via the cassette 26 and line 68 of the blood inlet/blood component tubing assembly 32. Separation processing then occurs on a substantially continuous basis in the blood processing vessel 12, i.e., blood flows substantially continuously therein, is continuously separated and flows as separated components therefrom. After separation processing in vessel 12 (though separation is continuously occurring), uncollected blood components are transferred from the processing vessel 12 to and through cassette 26, into reservoir 76 of cassette 26 up to a predetermined level. The blood component separation device 6 may initiate a blood return submode wherein components may be returned to the donor through return line 84. The cycle between blood removal and blood return submodes will continue until a predetermined amount of blood components have been harvested. In an alternative single needle scheme, as is known in the art, blood may be alternately removed from the donor and returned to a donor through a single needle.

A bracket (not shown) is provided on a top surface of the centrifuge assembly 16. The bracket releasably holds an LRS or cell separation chamber 134 on the centrifuge assembly 16 so that an outlet 136 of the cell separation chamber 134 is positioned closer to the axis of rotation than an inlet 138 of the chamber 134. The bracket orients the chamber 134 on the centrifuge assembly 16 with a longitudinal axis of the cell separation chamber 134 in a plane transverse to the rotor's axis of rotation. In addition, the bracket is arranged to hold the cell separation chamber 134 on the centrifuge assembly 16 with the cell separation chamber outlet 136 facing the axis of rotation. Although the chamber 134 is preferably on a top surface of the centrifuge assembly 16, the chamber 134 could also be secured to the centrifuge assembly 16 at alternate locations, such as beneath the top surface of the centrifuge assembly 16.

FIG. 3 schematically illustrates a portion of the blood processing vessel 12 and cell separation chamber 134. The blood processing vessel 12 has a generally annular flow path and includes an inlet portion 162 and outlet portion 164.

The inlet portion 162 includes an inflow tube 68 for conveying a fluid to be separated, such as whole blood, into the processing vessel 12. During a separation procedure, substances entering the inlet portion 162 flow around the vessel 12 and stratify according to differences in density in response to rotation of the centrifuge assembly 16. The outlet portion 164 includes outlets for the RBC line 70, the plasma line 94, and cell line 112 for removing separated substances from the separation vessel 12. Each of the components separated in the vessel 12 is collected and removed in only one area of the vessel 12, namely the outlet portion 164.

The outlet of the cell line 112 is connected to the cell separation chamber inlet 138 to pass the intermediate density components, including white blood cells, into the cell separation chamber 134. Components initially separated in the separation vessel 12 are further separated in the cell separation chamber 134. For example, white blood cells could be separated from plasma and platelets in the cell separation chamber 134. This further separation takes place by forming a saturated fluidized bed of particles, such as white blood cells, in the cell separation chamber 134. As schematically shown in FIG. 3, a plurality of pumps 184, 188, and 190 are provided for adding and removing substances to and from the blood processing vessel 12 and cell separation chamber 134. An inflow pump 184 is coupled to the inflow line 68 to supply the substance to be separated, such as whole blood, to the inlet portion 162. In addition, a first collection pump 188 is coupled to the cell line 112 connected to the cell separation chamber outlet, and a second collection pump 190 is coupled to the plasma collection line 94. The first collection pump 188 draws liquid and particles from the cell separation chamber outlet 136 and causes liquid and particles to enter the cell separation chamber 134 via the cell separation chamber inlet 138. The second collection pump 190, on the other hand, removes primarily low-density substances from the separation vessel 12 via the plasma line 94. The pumps 184, 188, and 190 are peristaltic pumps, which prevent significant damage to blood components. The pumps 184, 188, and 190 control the flow rate of substances flowing to and from the blood processing vessel 12 and the cell separation chamber 134. A saturated fluidized bed of particles is maintained within the cell separation chamber 134 to cause other particles to be retained in the cell separation chamber 134.

Blood within the processing vessel 12 is subjected to centrifugal force causing components of the blood components to separate. The components of whole blood stratify in order of decreasing density as follows: (1) red blood cells, (2) white blood cells, (3) platelets, and (4) plasma. The controller regulates the rotational speed of the centrifuge channel assembly 16 to ensure that this particle stratification takes place. A layer of red blood cells (high density components) forms along the outer wall of the processing vessel 12 and a layer of plasma (lower density components) forms along the inner wall of the processing vessel 12. Between these two layers, the intermediate density platelets and white blood cells (intermediate density components) form a buffy coat layer.

In the outlet portion 164, platelet-poor plasma flows through the line 94. These relatively low-density substances are pumped by the collection pump 190 through the plasma collection line 94. Red blood cells are removed via the RBC line 70. The red blood cells flow through the RBC line 70 and can then be returned to the donor or, alternatively, collected and optionally recombined with other blood components or further separated. Accumulated white blood cells are removed from the channel via the cell line 112, along with platelets and plasma. As the platelets, plasma, white blood cells, and possibly a small number of red blood cells pass through the line 112, these components flow into the cell collection chamber 134, so that a saturated fluidized particle bed may be formed.

In addition, the pump 188 conveys at least the plasma, platelets, and white blood cells at a predetermined flow rate through the cell collection line 112 and into the inlet 138 of the cell separation chamber 134. When the platelet and white blood cell particles enter the cell separation chamber 134, they are subjected to two opposing forces. Plasma flowing through the cell separation chamber 134 with the aid of pump 188 establishes a first viscous drag force when plasma flowing through the cell separation chamber 134 urges the particles toward the outlet 136. A second centrifugal force created by rotation of the channel assembly 16 and cell separation chamber 134 acts to urge the particles toward the inlet 138. The rotational speed of the centrifuge assembly 16 and the flow rate of the pump 188 causes platelets and white blood cells to collect in the cell separation chamber 134. As plasma flows through the cell separation chamber 134, the flow velocity of the plasma decreases and reaches a minimum as the plasma flow approaches the maximum cross-sectional area of the cell separation chamber 134. The white blood cells accumulate somewhat radially outward from the maximum cross-sectional area of the chamber 134.

In an apheresis blood collection system, such as the TRIMA ACCEL™ system available from CaridianBCT, Inc., characteristics of a donor, such as weight, sex, hematocrit, or platelet count, may be entered in the system and used to predict the amount of selected blood components that the donor may be able to donate in a reasonable period of time. The collected components are subsequently separated into units or “products” of appropriate sizes for administration to a patient. For example, a platelet product may comprise between 3×10¹¹ and 4.5×10¹¹ (“E11”) cells. A particular donor may be able to give twice or even three times this amount of platelets, which could be divided into a “double product” or a “triple product”. The exact amount of a donation is usually not known, however, until after the completion of the donation process. The apheresis machine uses information about the donor and statistical models to estimate the number of cells that will be collected for a certain volume of the donor's blood, processed over a selected period of time. In the past, the TRIMA ACCEL™ system has provided a selected number (e.g., six) targets for the number of cells to be collected. The present invention provides for multiple targets within ranges associated with the collection of, for example, single products, double products, or triple products.

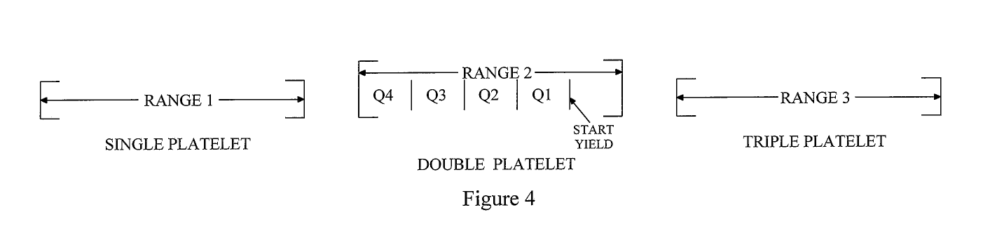

It is advantageous to collect a maximum number of products from a donor, but not to collect an excess number of cells above the number of cells required for the maximum possible number of products. Collecting excess cells needlessly depletes the cells of the donor, takes additional time both for the donor and the operator, and for the use of the machine, and wastes excess collected blood components. The present invention seeks to optimize collection of a reliable number of products by allowing an operator to select a target number of products, for example, a double platelet product. (See FIG. 4.) The apparatus selects a target number of cells (platelets) for collection within a preselected range, based on donor characteristics, and seeks to optimize the probability that the selected number of products will actually be collected. Multiple ranges are provided, for example, a range for a single product, for a double product, and for a triple product. The adjacent ranges are separated by zones which are numbers of cells that are too high for a lower range and too low for an adjacent higher range. The apparatus will not attempt to perform a process that would withdraw a number of cells within a zone.

For example, if a blood bank administrator had selected 3×E11 to 4.2×E11 as an acceptable platelet product, a “double” product could be taken from a donor if the donor could provide between 6×E11 and 8.4×E11 cells. It would be inadvisable to attempt to collect between 4.2×E11 cells and 6×E11 cells because the excess cells could not qualify as a second product, thus reducing productivity, needlessly depleting the number of cells for the donor, and wasting time for all involved. Similarly, a triple product could only be collected if the donor were capable of providing between 9×E11 and 12.6×E11 cells. The apparatus calculates the potential donation from factors such as the donor's height, weight, sex, hematocrit, platelet count, and prior donation history. If, for example, the apparatus calculates that a potential donor could theoretically provide 8.9×E11 platelets, the apparatus would allow the operator to select a double platelet product, comprising 8.4×E11 cells. The apparatus would calculate process parameters such as rate of blood processing and total processing time to allow such a collection. If a parameter is fixed, such as total process time, the target number of cells may be further reduced within the double platelet product range. None of the process parameters can be permitted to take values that would endanger the health of the donor.

Calculations of a donor's potential cell donation are based, in part, on average values for all donors. A particular donor's cell count will vary from the average values in a normal statistical variation. There is, therefore, a possibility that a particular donor's available platelets will vary significantly from the predicted value. If the number of available platelets is too low, the exemplary double platelet product may not actually be collected, despite a target in the acceptable range. Given the calculated maximum available number of platelets for a particular donor, the probability of actually collecting a double product (for example) can be calculated. Because there is a wider margin of error, there is a higher probability that an acceptable double product will actually be collected if the target is at the upper end of the range (e.g., 8.4×E11) than if the target is constrained by other factors to be at the lower end of the range (e.g., 6×E11). The apparatus, therefore, will attempt to keep the collection target as high as possible within the acceptable range.

Maximum possible platelet yield is limited to the largest yield limit that simultaneously meets each of the limits imposed (1) by the minimum post count concentration of platelets that must be retained by the donor for donor safety, (2) by the maximum procedure time, and (3) by the removed volume limit, that is, the maximum volume of blood that may be safely removed from the donor. For the optimum platelet collection conditions for a given procedure, each of these three limits is determined by extrapolation from the predicted conditions for an assumed start yield (see FIG. 4). The assumed start yield is either the target yield specified by the operator, or otherwise the post count-limited yield if maximum platelet yield is requested from the start. The prediction is not sensitive to the start yield, within reasonable bounds that include a configured minimum platelet yield.

The maximum platelet yield prediction process is: (1) predict procedure conditions for a start yield, (2) extrapolate from these conditions to determine the maximum yields allowed by procedure time and collect volume limits, (3) re-predict procedure conditions for the smallest of the three maximum yields, and (4) repeat step 2 and step 3 until the maximum platelet yield converges, or until the maximum number of predictions is reached. A convergence of <0.10×10¹¹ is obtained with usually two, sometimes three, and rarely four predictions required. The minimum number of predictions is two.

In determining maximum platelet yield, criteria for RBC products and fixed-volume plasma products, as set by a receiving blood center, must be met in order for a procedure to qualify. Maximum platelet and maximum collected plasma can be reduced to their minimum configured volume, and no-plasma procedures can qualify at zero available plasma.

### Post Count Limit

The maximum target yield (Y_{MP}) imposed by the minimum allowable platelet post count is independent of procedure conditions and is given by:

Y_{MP}=10⁻⁵(C_{PRE}−C_{POMIN})V_{B}≧0,10¹¹ plts (1)

where
C_{PRE}=donor platelet precount, 10⁶ plts/ml
C_{POMIN}=minimum configured post count, 10⁶ plts/ml
V_{g}=donor TBV, ml

### Procedure Time Limit

A linear extrapolation of procedure time, as a function of the inlet volume processed for the platelet collection phase, is given by:

t_{PMAX}=t_{PP}+[(V_{INTARG})_{MAX}(V_{INTARG})_{P}−1]t_{PCP}

or by:

(V_{INTARG})_{MAX}(V_{INTARG})_{P}=1+(t_{PMAX}−t_{PP})/t_{PCP} (2)

where
t_{PMAX}=maximum configured procedure time, min
t_{PP}=procedure time from previous prediction, min
t_{PCP}=platelet collection time from previous prediction, min
(V_{INTARG})_{P}=platelet collection inlet volume from previous prediction, ml
(V_{INTARG})_{MAX}=maximum platelet collection inlet volume for maximum platelet yield, ml

Equation 2 can also be express in terms of yields as:

(V_{INTARG})_{MAX}/(V_{INTARG})_{P}=[1−C₁ ln(1−C₂Y_{MT})]/[1−C₁ ln(1−C₂Y_{P})] (3)

with

C₁=V_{B}/(E_{CP}V_{SU}) (4)

C₂=10⁵/(C_{PRE}V_{B}) (5)

Equating equation (2) and (3), the maximum target yield imposed by t_{PMAX} is given by:

Y_{MT}=[1−exp(−C₃/C₁)]/C₂ (6)

with

C₃=[1+(t_{PMAX}−t_{PP})/t_{PCP}][1−C₁ ln(1−C₂Y_{P})]−1≧0 (7)

where
E_{CP}=platelet collection efficiency from previous prediction
V_{SU}=startup volume, ml
Y_{P}=yield for previous prediction, 10¹¹ plts

Note that the actual values of (V_{INTARG})_{P} and (V_{INTARG})_{MAX} are irrelevant, and only the ratio matters.

### Volume Limit

The maximum target yield imposed by the maximum volume that can be collected is given by linear extrapolation as:

V_{PMAXP}=V_{PMIN}+10⁵C_{B}(Y_{MV}−Y_{P})

Or

Y_{MV}=Y_{P}+10⁻⁵(V_{PMAXP}−V_{PMIN})C_{B} (8)

where
V_{PMAXP}=maximum plasma available from previous prediction, ml
V_{PMIN}=minimum acceptable plasma to be collected, ml
C_{B}=configured bag concentration, 10⁶ plts/ml
   V_{PMIN} is given by:

V_{PMIN}=V_{PTARG} for a specified fixed plasma volume

=minimum configured volume for maximum platelet or MC plasma

=0 for no plasma specified (9)

### Maximum Platelet Yield

Y_{AMAP}=MIN(Y_{MP},Y_{MT},Y_{MV})−Y_{MAR}≧Y_{MIN} (10)

where
Y_{AMAP}=maximum platelet yield
Y_{MAR}=prediction margin, 10¹¹ plts
Y_{MIN}=minimum configured maximum platelet yield, 10¹¹ plts

The first prediction uses the target yield specified by the operator, if there is one. Otherwise, Y_{MP} (see Equation 1, above), which is independent of procedure conditions, is used. The prediction results to be used in the algorithms are:
1. Yield, Y_{P}
2. Procedure time, t_{PP}
3. Platelet collection time, t_{PCP}
4. Maximum available plasma volume, V_{PMAXP}
5. Platelet collection efficiency, E_{CP}

### Convergence of Maximum Platelet Yield Prediction

Various convergence schemes can be used to qualify a maximum platelet yield of a set of procedures. The one now used, and explained more fully below, sets a balance between precision and speed of calculation by adopting the following limits:

Y_{MAR}=prediction margin, 10¹¹ plts=0.05

N_{P}=number of procedure predictions

Maximum N_{P}=10

Converge within 0.10, N_{P}≦4

Converge within 0.25, N_{P}>4

Other limits might be selected based on processing speed of the controller, the number of procedures available on a particular machine, and other similar factors.

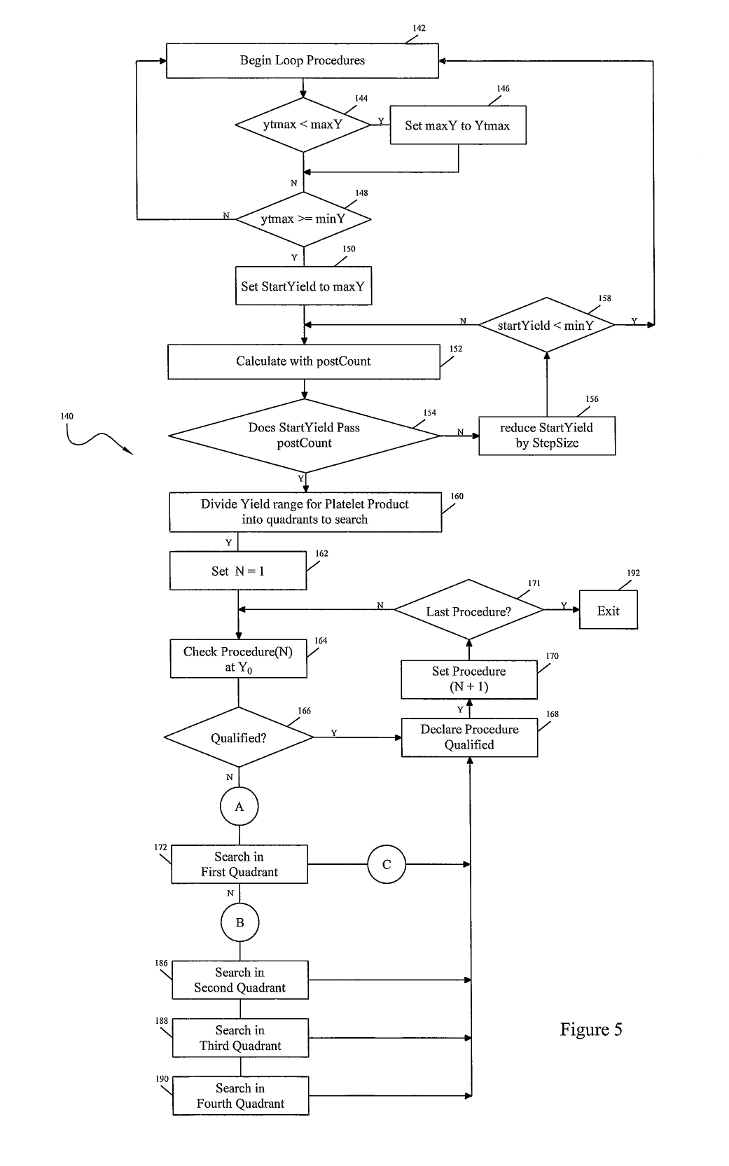

Based on the foregoing principles, a method can be provided to control an apheresis machine to maximize platelet collections. Such a method is illustrated in FIG. 4 and in the flow chart of FIG. 5 and may be implemented by computer code in a microcontroller in the apheresis system.

As shown in FIG. 4, a donor may be capable of donating a theoretical volume of platelets represented by “Start Yield”, a value which is calculated as explained below. In the situation illustrated in FIG. 4, the donor's Start Yield has been found to fall within the range assigned for a double platelet product. If the Start Yield fell within a zone between two ranges, the apparatus would only try to collect the maximum number of platelets allowed by the lower of the two ranges. Having determined that the donor is capable of donating a double platelet product, the apparatus must then determine which of various available procedures are allowed for the donor and what the maximum platelet target should be for each allowed procedure. It has been found that the maximum platelet target for an allowed procedure is often close to the Start Yield. The current convergence algorithm tries to minimize the calculations necessary to qualify a procedure and identify a yield target for that procedure by searching near the Start Yield first. As illustrated in FIG. 4, once a Start Target has been identified within a range, such as the double platelet product range, the controller divides the area between the Start Target and the lower limit of the range into four quadrants. Clearly, other divisions could be used. For a particular procedure (for example, collecting a single red blood cell product, a double platelet product, and a plasma product) the controller runs a Check Procedure subroutine with a target volume for platelets set at Start Target. If the procedure passes the Check Procedure subroutine, no further search is necessary, and the procedure can be declared available. If not, the controller will try a platelet target value at the bottom of the first quadrant, Q1. If this value does not pass the Check Procedure subroutine, the controller will try the lowest value in Q2, and, if necessary, Q3 and Q4. If the procedure does not pass the Check Procedure subroutine at the lowest value of Q4, the procedure is unavailable and cannot be selected for the donor. If the procedure does pass the Check Procedure subroutine for the lowest value in Q1, the controller will then decrement the Start Yield by a step (e.g., 0.1) and retest the procedure until the maximum platelet target for that procedure has been identified.

The same process is applied for Q2, Q3, or Q4, if the procedure passes the Check Procedure subroutine for the lowest value of a particular quadrant, but does not pass for the lowest value for the next higher quadrant.

The entire process is repeated for each of a plurality of procedures available on the particular blood processing apparatus until a set of available procedures has been identified and can be presented to an operator for selection. The process is also repeated at intervals during a selected procedure and if a significant change is detected to assure that the selected procedure is still available for the donor.

At the beginning of an apheresis procedure and during blood processing, the program 140 is implemented by the apheresis system 6. The controller (not shown) invokes the program 140 as a subroutine of a blood processing program. The program begins 142 and initially compares 144 a yield target maximum (ytmax) to a maximum yield (maxY). The maximum yield is set by the operator or by a system administrator as part of standard operation procedures for the blood collection organization. The yield target maximum is calculated by the controller from donor-specific parameters such as weight, gender, platelet count, which are measured by or entered into the apparatus. In addition, the yield target maximum may be derived, as mentioned above, from the donor's donation history. For example, a separate database may be maintained with information on a donor's prior donations. Such a database system is described in U.S. Pat. No. 7,072,769 and is available from CaridianBCT, Inc. as the VISTA® Information System. Such a database system, being connected to the apheresis system 6, can provide the controller with donation information, including platelet yields. The donor's history, as contained in the database, may indicate, for example that the particular donor usually has a particularly high platelet count as compared to an average donor. Under these circumstances, it would be appropriate for the controller to select a higher yield target maximum than would be predicted from the weight, gender, or average platelet count alone. The yield target maximum represents the theoretical maximum quantity of platelets that could be collected from the particular donor. If the yield target maximum is less than the maximum yield (the usual case), maximum yield is changed 146 to the yield target maximum. The yield target maximum is also compared 148 to a minimum yield (minY), which, like the maximum yield, is set by the operator or by a system administrator. If the yield target maximum is less than the minimum yield, a platelet product should not be collected and the donor is declared to be ineligible for a platelet donation in the particular range for a selected product.

The preselected limits maxY (maximum yield) and minY (minimum yield) define a range for a particular product. Thus, it may be desired to configure the machine to collect a single platelet product, a double platelet product or a triple platelet product. Each product would have a maxY and a minY associated with that product. If a donor does not qualify to donate a triple product, the donor might nevertheless qualify to donate a double or a single product. The qualifying program outlined above would, therefore, be attempted with the limits maxY and minY associated with a double or single product.

After the donor is qualified for a product, the controller then initializes 150 a variable for the starting approximation of the platelet yield (StartYield) by setting StartYield equal to maxY. The controller calculates 152 a quantity of platelets that are predicted to remain in the donor after the donation (PostCount). The value of PostCount is calculated from the donor-specific parameters, as mentioned above, less the quantity of platelets to be collected from the donor, but must exceed a minimum value comprising the greater of a pre-set minimum or a donor-specific, calculated minimum. Calculation of a PostCount limit is known in the art. If the StartYield does not meet 154 the PostCount criteria for safety, the StartYield is reduced 156 by a selected value or step size, then re-tested 158 to confirm that StartYield exceeds the pre-selected minimum yield, minY. If the StartYield has been decreased below the minimum yield minY, the subroutine 140 is interrupted and the donor is again declared ineligible for platelet collection. Otherwise, the new value for StartYield is re-tested 152 against the PostCount criteria.

The parameter StartYield has, by this process, been identified and qualified as meeting the preselected limits maxY and minY and the donor-specific limits yield target maximum (ytmax) and the PostCount criterion and as falling within a range, such as the range for a double platelet product.

The controller can now search for a maximum platelet yield associated with a plurality of procedures which may be available on the apparatus. A typical procedure might be collecting a single red blood cell product, a double platelet produce and a single plasma product. A Yield Range may be defined 160 as a range bounded by the minimum value for the current range, as a lower limit, and the StartYield value as an upper limit. The Yield range is divided into four quadrants, numbered herein from 1 (highest) to 4 (lowest). An index N, representing a procedure, is initialized to 1 at step 162. A Check Procedure algorithm is called 166 to determine if the procedure (N) can be run successfully with the platelet target set at Y₀, that is, the StartYield. A Check Procedure algorithm is dependent on the particular apparatus and the parameters selected for the procedure by the organization or individual operating the apparatus. Such algorithms are known in the art and have been used, for example, in the TRIMA ACCEL™ apheresis machine. If the procedure passes 166 the Check Procedure step, the controller declares 168 the procedure qualified or allowed at a platelet yield target of Y₀. The index N identifying a procedure is incremented 170, and tested 171 to determine if all procedures have been considered. If a procedure still needs to be tested, the controller returns to the Check Procedure step 164.

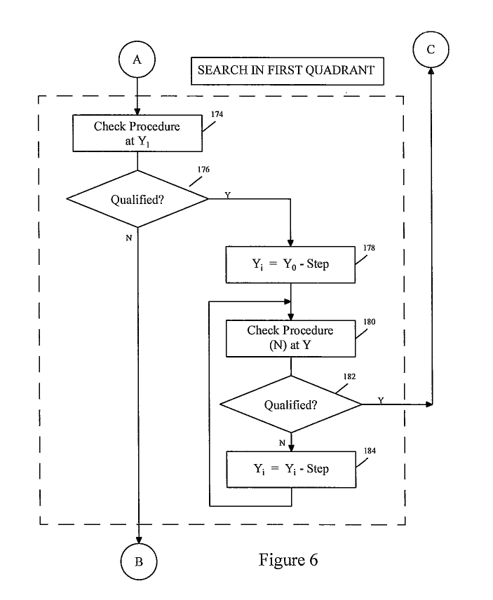

If the procedure does not qualify 166 at the StartYield value Y₀, the controller will begin to search for a maximum platelet yield target by quadrants, as previously defined. It has been determined that it is likely that a valid yield target for a procedure will be found close to the StartYield, most probably in the first or highest quadrant. The controller, therefore, starts to search 172 the first quadrant. Each of the quadrant searches, if necessary, is similar to the search described in connection with the first quadrant, Q1, as shown in FIG. 6. The controller invokes 174 the Check Procedure subroutine for the target yield Y₁, the boundary value between Q1 and Q2 and the lowest value in Q1. If the procedure is not qualified 176 at this value, the controller will search in the second quadrant Q2 (step 186) or in the third quadrant Q3 (step 188) or, finally, the fourth quadrant Q4 (step 190).

If the procedure qualifies 176 at Y₁, the controller tries to identify the maximum platelet yield within the quadrant, since Y₁ represents the minimum value for the quadrant. The controller sets 178 a target yield Y₁ to Y₀, the maximum for the quadrant, less a step, for example 0.1. Check Procedure is again invoked 180 for the value at Yᵢ. If the procedure qualifies 182, the controller adds 168 the procedure to the allowed list at the tested platelet yield and goes on 170 to the next procedure. If the procedure does not qualify 182, Yᵢ is reduced 184 by another step, and the procedure is tested 180 again.

After a maximum platelet yield has been identified for each allowed procedure, and all procedures have been tested 171, the controller can exit 192 the subroutine 140.

After the operator has selected a procedure from a list of allowed procedures offered by the apparatus, and the procedure is running, the controller will return to the subroutine 140 at selected intervals or if there is a significant change in operating conditions (for example, a pause in the process). The controller may adjust the platelet yield target up or down within a range such that the procedure can still be completed despite some changes in conditions, without requiring operator intervention. If the platelet yield target falls into a zone between ranges or into another range (whereby the selected procedure would be disqualified), the operator would be notified and would select a new procedure from a newly-generated list of allowed procedures.

The apparatus, therefore, will collect a maximum amount of platelets for a selected procedure without collecting excess platelets above those required for the selected platelet product, whether that product was one unit of platelets, two units of platelets (a double platelet), or more. Moreover, the apparatus will continue to adjust the target for platelet collection throughout the procedure without operator intervention, unless the selected procedure cannot be completed successfully, and the operator is required to select another procedure. As a consequence of the search for allowable target yields within regions, the target yields cannot take values in zones between regions, thereby eliminating the attempted collection of platelets in excess of those required for a selected product.

Although the inventive device and method have been described in terms of filtering white blood cells, this description is not to be construed as a limitation on the scope of the invention. It will be apparent to those skilled in the art that various modifications and variations can be made to the structure and methodology of the present invention without departing from the scope or spirit of the invention. Rather, the invention is intended to cover modifications and variations provided they come within the scope of the following claims and their equivalents.

What is claimed is:

1. A method for controlling a centrifugal blood separation device comprising
identifying a maximum quantity of platelets that a donor is qualified to donate,
identifying a range of platelet quantities containing said maximum quantity, said range comprising allowed platelet quantities associated with a discrete platelet product amount,
identifying a procedure-specific quantity of platelets for each of a plurality of blood collection procedures, said procedure-specific quantity being less than said maximum quantity, being within said range, and being a maximum for a specific procedure, and
collecting said procedure-specific quantity of platelets in connection with its associated specific procedure.

2. The method of claim 1 further comprising identifying a plurality of ranges, each range being separated from an adjacent range by a zone.

3. The method of claim 2 wherein said ranges comprise a single product range, a double product range, and a triple product range.

4. The method of claim 3 wherein each range is defined by a preselected maximum yield and a preselected minimum yield.

5. The method of claim 2 wherein said procedure-specific quantities of platelets are not allowed to take values within said zones.

6. The method of claim 1 further comprising repeating said identifying steps during a procedure and adjusting said procedure-specific quantity.

7. The method of claim 6 further comprising
repeating said identifying steps at selected intervals or if there is a selected change in operating conditions.

8. The method of claim 7 further comprising automatically adjusting the platelet yield target within a range.

9. The method of claim 7 further comprising
determining if the adjusted procedure-specific quantity falls into a zone between ranges or into another range, and
notifying an operator to select a new procedure if the adjusted procedure-specific quantity falls into said zone between ranges or into another range.

10. The method of claim 6 further comprising
selecting an alternative procedure when a selected procedure is no longer qualified to collect an acceptable quantity of platelets, and
collecting a procedure-specific quantity of platelets associated with said alternative procedure.

11. The method of claim 1 wherein said step of identifying a maximum quantity of platelets that a donor is qualified to donate further comprises calculating a maximum quantity from donor-specific parameters comprising weight, gender, and platelet count.

12. The method of claim 1 wherein said step of identifying a maximum quantity of platelets that a donor is qualified to donate further comprises accessing a record of said donor's donations from a database.

13. A blood cell collection system comprising
a centrifuge rotor;
a blood processing chamber mounted on said rotor;
means for collecting a maximum amount of platelets for a selected platelet product without collecting excess platelets.

14. The blood cell collection system of claim 13 further comprising means for:
(a) identifying a maximum quantity of platelets that a donor is qualified to donate,
(b) identifying a range of platelet quantities containing said maximum quantity, said range comprising allowed platelet quantities associated with a discrete platelet product amount,
(c) identifying a procedure-specific quantity of platelets for each of a plurality of blood collection procedures, said procedure-specific quantity being less than said maximum quantity, being within said range, and being a maximum for a specific procedure, and
(d) collecting said procedure-specific quantity of platelets in connection with its associated specific procedure.

15. The blood cell collection system of claim 14 further comprising means for identifying a plurality of ranges, each range being separated from an adjacent range by a zone.

16. The blood cell collection system of claim 15 wherein said ranges comprise a single product range, a double product range, and a triple product range.

17. The blood cell collection system of claim 16 wherein each range is defined by a preselected maximum yield and a preselected minimum yield.

18. The blood cell collection system of claim 15 wherein said procedure-specific quantities of platelets are not allowed to take values within said zones.

19. The blood cell collection system of claim 14 further comprising means for repeating said identifying steps during a procedure and adjusting said procedure-specific quantity.

20. The blood cell collection system of claim 19 further comprising
means for repeating said identifying steps at selected intervals or if there is a selected change in operating conditions.

21. The blood cell collection system of claim 20 further comprising means for automatically adjusting the platelet yield target within a range.

22. The blood cell collection system of claim 20 further comprising
means for determining if the adjusted procedure-specific quantity falls into a zone between ranges or into another range, and
means for notifying an operator to select a new procedure if the adjusted procedure-specific quantity falls into said zone between ranges or into another range.
